(19) United States
(12) Patent Application Publication
(10) Pub. No.: US 2004/0249939 A1
(43) Pub. Date: Dec. 9, 2004

(54) Methods and apparatus for dynamic and optimal server set selection

(75) Inventors: Lisa D. Amini, Yorktown Heights, NY (US); Peter W. Gayek, Chapel Hill, NC (US); Anees A. Shaikh, Yorktown Heights, NY (US); Brian J. Snitzer, Raleigh, NC (US)

Correspondence Address: Ryan, Mason & Lewis, LLP, 90 Forest Avenue, Locust Valley, NY, 11560, US

(73) Assignee: International Business Machines Corporation, Armonk, NY

(21) Appl. No.: 10/444,400

(22) Filed: May 23, 2003

(51) Int. Cl. G06F 15/173

(52) U.S. Cl. 709/225

(57) ABSTRACT

Techniques for dynamically and optimally selecting one or more computing systems, e.g., a server set, to which another computing system, e.g., a client device, is to be directed. The computing systems may be part of a distributed computing network. For example, such techniques may include the following steps/operations. First, input data is obtained. An assignment is then computed based on at least a portion of the obtained input data. In one embodiment, the input data is represented as a graph, wherein the graph represents client-based content request information as flow data and fees charged by server sets as cost data. One or more optimization operations are then applied to the flow data and the cost data so as to maximize flow, minimize cost, and ensure client cluster to server set assignments are within a specified network delay threshold. A reference list, e.g., map, is then computed based on results of the optimization operations. The reference list is useable for selecting, upon request, a server set to which a client device is to be directed, e.g., so as to provide computing services.

### FIELD OF THE INVENTION

The present invention relates to management of a computing system, such as a federated computing system, in a distributed computing network and, more particularly, to techniques for dynamically and optimally selecting from amongst multiple server sets in order to provide computing services to a client device.

### BACKGROUND OF THE INVENTION

More and more, computing systems are being deployed by computing service providers (also referred to as eUtility providers) responsible for acquiring, provisioning, and managing computing servers, network connectivity and lab-space for their customers. In advanced scenarios, the eUtility provider may partner with other eUtility providers to meet customer needs. For example, instead of overprovisioning data centers for potential surges in demand, or deploying specialized servers for customer workloads, an eUtility provider may prefer to offload computing needs to partner eUtilities. Such federated approaches have been proposed as part of the CDI (Content Distribution Internetworking) and Grid efforts, see, respectively, e.g., M. Day et al., “A Model for CDN Peering,” IETF Internet-draft, November 2000; and I. Foster et al., “The Anatomy of the Grid,” International Journal of Supercomputer Applications, November 2001.

In this federated approach to computing, services may be delivered via a distributed computing network, such as the TCP/IP (Transmission Control Protocol/Internet Protocol) based network of the Internet, and client devices may be redirected from a first server (or server set) to a second server (or server set) such that the second server set can provide services to the client device. Typically, client device redirection happens either when the client device attempts to resolve an IP domain name (e.g., www.abc.com) into an IP address (e.g., 9.2.10.0), or when the client device sends a request, such as an HTTP (HyperText Transport Protocol) request, to the first server.

A Domain Name System or DNS can provide redirection when the client device attempts to resolve an IP domain name into an IP address. DNS redirection is a common method used in dynamic server selection schemes, and is widely used by existing CDSPs (Content Delivery Service Providers).

As an example of how a DNS can be used to redirect client device requests, the DNS server can receive a DNS request to resolve an IP domain name. If the client IP address is to be served by the origin website, the DNS would return the IP address of the origin website to the client device. If the client IP address is to be served by a remote server set, the DNS server can resolve this name to an alternate, or alias, IP domain name. This type of redirection is often referred to as DNS CNAME (Canonical Name) redirection. The CNAME will be an IP domain name in the namespace of the selected server set. The client device then queries the authoritative DNS of the CNAME in order to resolve the CNAME to the IP address of the server to which the CDN (Content Delivery Network) wishes to redirect the client device. Once a client device receives an IP address, it can establish a session directly to the server assigned the specified IP address.

### SUMMARY OF THE INVENTION

The present invention provides techniques for dynamically and optimally selecting one or more computing systems to which another computing system is to be directed, e.g., so as to provide computing services. The computing systems may be part of a distributed computing network.

In one aspect of the invention, a technique for generating a reference list (e.g., map) for use in selecting at least one computing system (e.g., server or server set) associated with a first plurality of computing systems (e.g., group of all server sets to be considered) to which another computing system (e.g., client device) associated with a second plurality of computing systems (e.g., group of all client device clusters to be considered) is to be directed, includes the following steps/operations.

First, input data is obtained. The input data includes information associated with the first plurality of computing systems, information associated with the second plurality of computing systems, and information associated with content requests made by at least a portion of the second plurality of computing systems.

Next, a minimum cost assignment is computed based on at least a portion of the obtained input data. In the case where the first plurality of computing systems is a collection of server sets and the second plurality of computing systems is a collection of client clusters, the technique assigns client clusters from the second plurality of computing systems to server sets from the first plurality of computing systems. The assignment may be performed such that the client clusters are assigned only to those server sets within a configurable network delay threshold, the resource limits of the server sets are not exceeded, and the assignment minimizes the cost associated with delivering the workload imposed by the client clusters.

In one illustrative embodiment, the invention may provide a low latency assignment by computing a bipartite graph, based on at least a portion of the obtained input data. The graph may represent the client cluster request information as flow data, and fees charged by computing systems associated with the first plurality of computing systems as cost data. One or more optimization operations may then be applied to the flow data and the cost data so as to maximize flow, minimize cost, and ensure client cluster to server set assignments are within a specified network delay threshold.

Lastly, a reference list (e.g., map) is computed based on the minimum cost assignment. The reference list may then be useable for selecting, upon request, at least one computing system associated with the first plurality of computing systems to which a computing system associated with the second plurality of computing systems is to be directed.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1A is a block diagram illustrating a server selection system, according to an embodiment of the present invention;

FIG. 1B is a block diagram illustrating a map builder, according to an embodiment of the present invention;

FIG. 2 is a flow diagram illustrating a map creation methodology for use by a server selection system, according to an embodiment of the present invention;

FIG. 3 is a diagram illustrating a bipartite graph for use in a map creation methodology, according to an embodiment of the present invention; and

FIG. 4 is a block diagram illustrating an exemplary computing system environment for implementing a server selection system, according to an embodiment of the present invention.

### DETAILED DESCRIPTION OF PREFERRED EMBODIMENTS

The following description will illustrate the invention using an exemplary DNS redirection environment for content delivery services. It should be understood, however, that the invention is not limited to use with any particular environment. The invention is instead more generally applicable for use with any federated computing environment in which it is desirable to dynamically and optimally select a computing system for providing services to another computing system. It is to be appreciated that, in the following detailed description, the phrase “client device” may sometimes be replaced for convenience by the term “client.”

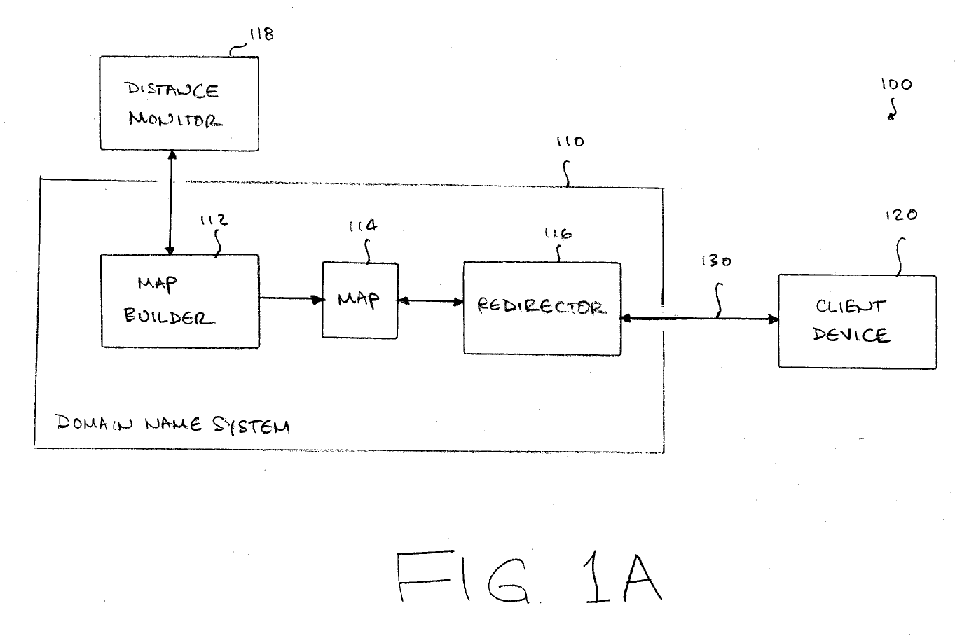

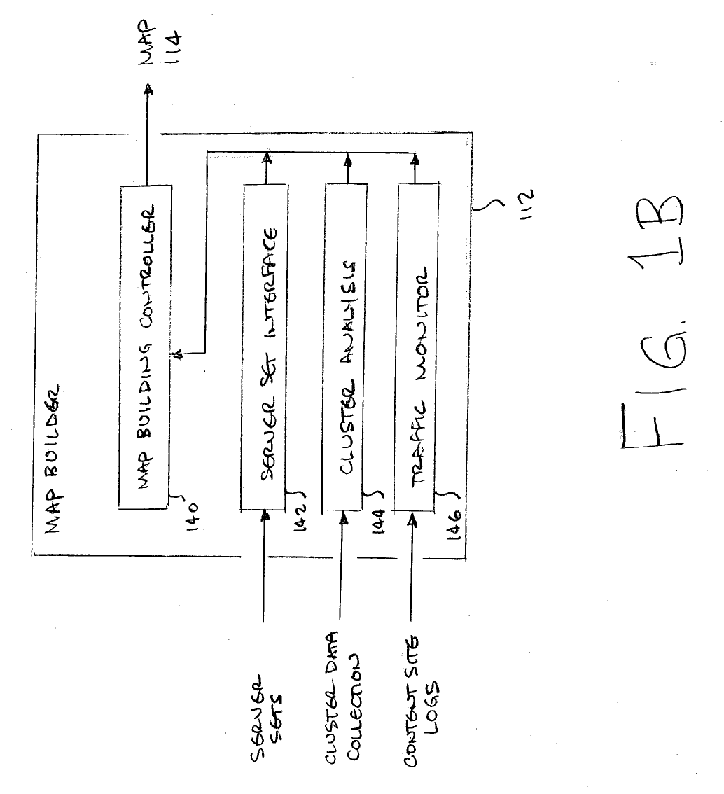

Referring initially to FIG. 1A, a block diagram illustrates a server selection system, according to an embodiment of the present invention. As shown, in distributed computing network 100, a domain name system (DNS) 110 is coupled to a client device 120 via a communications link 130. Further, as shown in FIG. 1A, DNS 110, itself, includes a map builder 112 and a redirector 116. Also shown in FIG. 1A is distance monitor 118. Its function will be described in detail later when explaining determination and use of a distance measure.

In this illustrative embodiment, DNS 110 operates as the server selection system of the invention. It is to be understood that DNS 110 may be implemented by one or more servers. Also, while FIG. 1A illustrates a single client device coupled to DNS 110 for the sake of simplicity, it is to be further understood that a plurality of client devices, as well as other servers and other devices, are typically coupled to DNS 110 to utilize its server selection functionality. Examples of client devices may be personal computers, mobile phones, personal digital assistants, etc.

In general, map builder 112 creates map 114 that redirector 116 uses, upon receipt of a request, to optimally determine where a given client device, e.g., client device 120, should be directed. For example, redirector 116, upon receiving a request to resolve an IP domain name from client device 120 with a given IP address, determines the appropriate response for this IP domain name/IP client address pair based on information in map 114. Note that the client-side IP address may be the address of an agent acting on behalf of the client. An example of such an agent is a DNS local to the client, which may be caching DNS requests for multiple clients. The response may be in the form of an IP address (to an origin website server), or an IP domain name (CNAME representing a server set remote from the origin website). The response is obtained from map 114 which may be in the form of a lookup table, illustrative details of which are described later. The invention, however, is not limited to any particular table or mapping format.

It is to be understood that map 114 will typically be built prior to receipt of a specific client request. However, all or portions of the map building process could alternatively be performed during and/or after receipt of a specific client request. Nonetheless, once the map is built and provided to redirector 116, the redirector uses the map to redirect clients. Advantageously, in accordance with the invention, map 114 enables redirector 116 to select the optimal server set to which the client is to be redirected.

Referring now to FIG. 1B, a block diagram illustrates a map builder (e.g., map builder 112 of FIG. 1A), according to an embodiment of the present invention. As shown, map builder 112 includes a map building controller 140, a server set interface 142, a cluster analysis module 144, and a traffic monitor 146. As will be explained in detail below, map building controller 140 controls construction of map 114 based on information from a server set interface 142, a cluster analysis module 144, and a traffic monitor 146. In particular, server set interface 142 provides server set attribute information to controller 140 based on data received from the server sets in the distributed system. Cluster analysis module 144 provides cluster location information to controller 140 based on data collected from the client clusters. Cluster analysis module 144 may implement a clustering methodology to be illustratively described below. Traffic monitor 146 provides content load information to controller 140 based on client content request data received from content site logs.

The following portion of the detailed description will now illustratively explain how a map is created in accordance with the principles of the present invention. More particularly, the description will focus on how the invention solves the problem of creating a map to enable dynamic, cost-optimized management of content delivery service offload to remote server sets, i.e., dynamic and optimal server set selection.

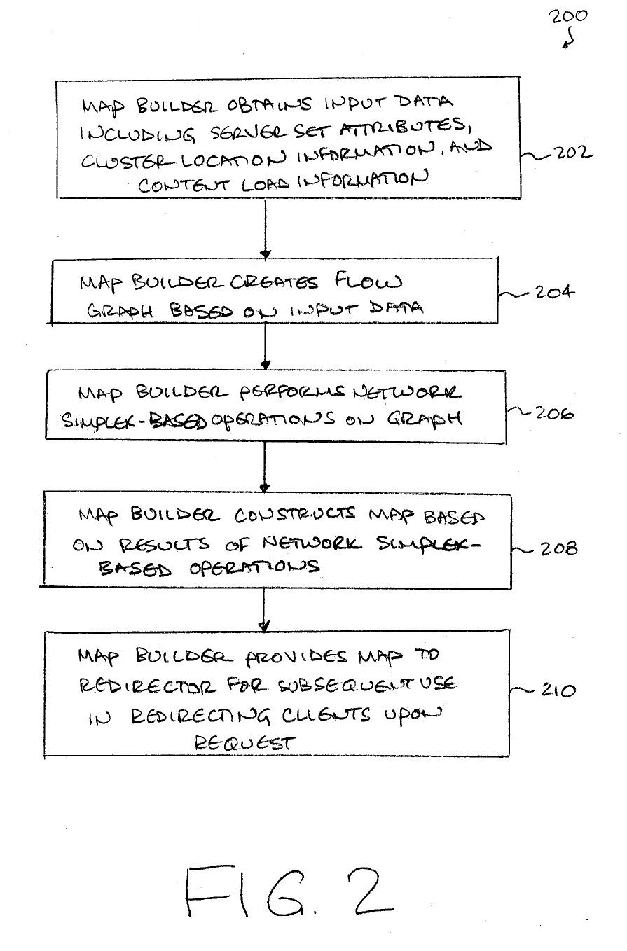

Referring now to FIG. 2, a flow diagram illustrates a map creation methodology for use by a server selection system (e.g., DNS 110), according to an embodiment of the present invention. Map creation methodology 200 begins, at step 202, with map builder 112 obtaining input data to be used to create map 114. The input data includes server set attribute information, cluster location information, and content load (with respect to client content requests) information. Following the description of how this input data is used by map builder 112, a description of how this information is generated will be provided.

For each server set to be considered in the map creation process, map builder 112 inputs and maintains the following data:

SSET_ID—an identifier that uniquely identifies a set of servers deployed by a partner CDN.

SSET_CNAME—the DNS name to which clients should be redirected when this server set will service the clients.

SSET_MAX_CAPACITY—maximum capacity contracted from server set.

SSET_SERVICE_POINTS—list of service points for a server set. For this illustrative description, we will assume these service points are identified by an IP address.

SSET_COST—cost per kilobyte served. Alternate units may be supported. How such alternate units can be supported will be described later.

If a service provider chooses to partition server sets (for example, according to the type of content served), a SSET_CONTENT_TYPE attribute can also be specified for each server set.

For each cluster (or client set, which will be further described below) to be considered in the map creation process, map builder 112 inputs and maintains the following data:

CLUSTER_ID—an identifier that uniquely identifies a set, or cluster, of IP addresses with similar location in a network. How similarity may be defined will be described later when explaining how the data is gathered.

CLUSTER_DESCRIPTION—information required to map an IP address into a unique cluster. For this illustrative description, it will be assumed that clusters can be described by one or more IP network addresses. IP network addresses can be compactly identified by specifying an address prefix and network mask. For example, 9.2.10.0/24 is used to refer to all IP addresses in the range 9.2.10.0 to 9.2.10.255, and is generally referred to as an IP address prefix.

CLUSTER_LOCATION—information required to determine the expected distance between a pair of clusters. Because different content providers may have different requirements in terms of whether this expected distance should be in terms of geographic location, or network topological distance (in terms of expected latency or round trip time RTT), the invention enables a content publisher to determine the expected delay based on different forms of location data. For this reason, the cluster location will be referred to abstractly when describing the map creation methodology, but specific examples of location will be detailed below when describing how data is gathered. That is, the distance between a pair of clusters will generically be referred to as distance (C1,C2). The distance function will calculate the distance based on the CLUSTER_LOCATIONs of C1, and C2, in a manner specific to the type of distance information maintained. Illustrative embodiments of the distance function will be detailed later.

CLUSTER_REQUEST_RATE—number of requests received per unit of time from clients in the associated cluster. How this information is maintained (even when the cluster is primarily served from remote server sets) will be detailed later.

CLUSTER_REQUEST_VOLUME—the request rate of the cluster in kilobytes served.

Note that a content publisher may have multiple sets of content, with different request rates, and different content types. Likewise, the service provider may provide services to multiple content publishers, using this same federated service provider infrastructure. These, and other special cases, are supported by the present invention and will be described later.

The content load information is specific to a content set and can be obtained from one or more sources. For example, content delivery servers, such as a WebSphere Edge Server available from IBM Corporation (Armonk, N.Y.), can be configured to log the IP address and requested content, among other attributes, of each client request. Alternatively, IP address and request information can be collected from intelligent content-level switches, such as a WebSphere Network Dispatcher available from IBM Corporation (Armonk, N.Y.).

Using this information, in step 204, map builder 112 creates a flow graph. More particularly, the map builder creates a bipartite graph based on the input data. This construction is selected because it enables the map builder to use an efficient network simplex algorithm belonging to a class of algorithms generally known as Max-Flow, Min-Cost (MFMC) algorithms, see, e.g., R. Ahuja et al., “Network Flows: Theory, Algorithms, and Applications,” Prentice-Hall, pp. 402-452, 1999, the disclosure of which is incorporated by reference herein. The network simplex algorithm accepts graphs in which nodes are connected via edges, and these edges are assigned a flow capacity, and a cost. In this context, the flow refers to client requests for content (i.e., content load information), and the cost refers to the fees charged for use of the server set. While alternative MFMC algorithms could be used to solve this minimum cost flow assignment, the network simplex algorithm is known to be efficient for solving a wide range of constrained optimization problems.

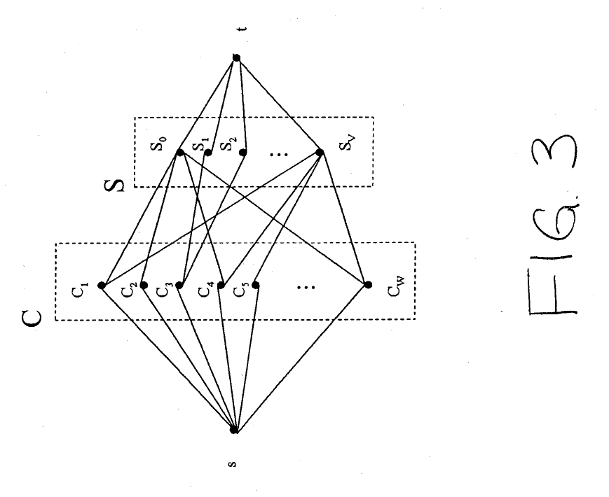

The following description details the mapping of the previously-described inputs to the graph components. First, a description of the nodes and edges of the graph will be given, followed by an illustration of how map builder 112 uses this graph to find an assignment of clusters to server sets that will minimize the expected cost to service the expected request rate of the clusters, with the constraint that the expected latency is less than a specified threshold value. More specifically, the map builder constructs a graph with nodes and edges as depicted in FIG. 3 and described below. The resulting graph is bipartite.

As shown in FIG. 3, for each cluster (or client set) with CLUSTER_REQUEST_RATE!=0, a single node, Cᵢ, is defined and the set of all nodes representing all clusters is referred to as C. The CLUSTER_REQUEST_RATE may be reduced by P*CLUSTER_REQUEST_RATE, where P represents the minimum fraction of requests from each cluster that is to be served from the origin site. The total number of clusters is referred to as W=|C|. For each server set, a single node Sⱼ, is defined and the set of all nodes representing all server sets is referred to as S. The total number of server sets is referred to as V=|S|. Note that S also includes a node representing the content publisher's origin site, this node is referred to as S₀. As is common in formulating flow graphs, a single source node s and a single target node t are defined.

Each edge in the graph is assigned a capacity, and a cost. For each Cᵢ, there is an edge from s with capacity=CLUSTER_REQUEST_VOLUME and cost=0. For each Sⱼ, there is an edge going to t with capacity=SSET_MAX_CAPACITY and cost=SSET_COST; the edge (S₀,t) has cost=0, and capacity equal to the maximum desired load for the origin site, reduced by P*V. V is the sum of CLUSTER_REQUEST_VOLUME over all clusters, and P is the minimum percentage of request volume for each cluster that should be served from the origin site. This minimum percentage is maintained so that the CLUSTER_REQUEST_RATE and CLUSTER_REQUEST_VOLUME can be estimated even when the cluster is being served from a remote server set.

For each Cᵢ, there is an edge going to each node (Sⱼ) in S for which distance (Cᵢ, Sⱼ)<T, where T is the threshold value defined for the maximum expected latency; for these edges, the cost=0 and capacity=CLUSTER_REQUEST_VOLUME. The capacity of an edge (Cᵢ, Sⱼ) is referred to as uᵢⱼ, and the cost is referred to as cᵢⱼ. How distance between a cluster node and surrogate set is defined will be described when defining how distance is calculated in general.

Nodes and edges of the graph may be adjusted due to certain content provider criteria or special case operating environments.

For example, a server set provider may wish to specify pricing tiers. That is, the server set provider Sᵢ may offer to service a request volume Vᵢ₁ for a fee Fᵢₗ, but for a request volume Vᵢ₂>Vᵢ₁, the fee may be higher (Fᵢ₂>Fᵢ₁). Such cases can be handled by creating two nodes, Sᵢ₁, and Sᵢ₂, for this service provider, with capacities Vᵢ₁ and Vᵢ₂-Vᵢ₁, respectively. The cost of edges (Sᵢ₁,t) and (Sᵢ₂,t) would be Fᵢ₁ and Fᵢ₂, respectively.

As a second example, a content publisher may be willing to direct requests to server sets that are beyond the network distance threshold. For example, if the content publisher is hosting content for a customer, the content publisher may have an arrangement such that if the network distance between the client and server is greater than the threshold, the content publisher will adjust the fees charged the customer by a specified penalty. Such cases can be handled by not limiting the edges between nodes in C and S to those within the network distance threshold. Edges between clusters and server sets which meet the distance threshold criteria will continue to have cost=0, as described previously. However, edges between clusters and server sets which exceed the distance threshold will have a cost equal to the agreed upon penalty.

As a third example, a service provider may wish to host multiple content publishers on a single federated computing infrastructure. We describe the case where a second content publisher is to be added to the graph described in the preceding paragraphs. This procedure can be repeated for additional content publishers. First, a separate content publisher source node, CP2, is created for the second content publisher. Further, each of the client cluster nodes is replicated in the graph, each with an edge connecting the client cluster to CP2 with the capacity equal to the load imposed by the client clusters accessing content provided by CP2, and cost as described for the initial content publisher. Finally, edges connecting the newly inserted client cluster nodes are connected to the server set nodes, with capacity equal to the load imposed on CP2 by the client clusters, and cost as described for the initial content publisher. The graph is otherwise unchanged.

As a fourth example, a service provider may support only specific content types and the content publisher may have specific content type service requirements. To support such environments, the content publisher workload can be partitioned according to the content type service requirements. Each of these partitions can be handled as described in the preceding paragraph, for multiple content publication nodes. In addition to the graph modifications described for supporting multiple content publishers, the edges drawn from the client cluster nodes to the server set nodes would be inserted only if the client clusters and server sets were within the network delay constraint (as in previous scenarios) and if the server sets were capable of servicing the content types required by the content publisher node.

Once the graph is created, map builder 112 performs operations associated with a network simplex algorithm, in step 206. The network simplex algorithm works in an iterative fashion, the details of which are now summarized.

In the initialization phase, an initial feasible solution is created. This initial solution is not necessarily the minimum cost solution, but it is feasible in that it does not violate the cost or capacity restrictions of individual edges. This initial solution is in the form of a spanning tree. The spanning tree of a graph G with N nodes is a subgraph of G with exactly |N|−1 edges that connects all vertices in G. In each iteration of the network simplex algorithm, a non-tree edge that currently violates its optimality condition is located, added to the tree to create a negative cycle, and flow around this cycle is augmented until the cycle reaches its upper or lower bound. The edge whose flow reaches this upper or lower bound is then deleted, which causes the subgraph to return to a spanning tree form. This procedure is repeated until the spanning tree with the minimum cost assignment is located. This minimum cost assignment condition can be detected since no non-tree edges remain that violate their optimality condition.

The output of the network simplex-based operations is a labeled version of the graph, in which each edge (Cᵢ, Sⱼ) is labeled with a value fᵢⱼ<uᵢⱼ. The value fᵢⱼ is the portion of Cᵢ's CLUSTER_REQUEST_VOLUME that should be directed to Sⱼ.

In step 208, map builder 112 then constructs map 114 as follows.

For each cluster (Cᵢ), an entry in the map is created in the following form:

Cᵢ.CLUSTER_DESCRIPTION Aᵢ₁ Aᵢ₂ . . . Aᵢₖ

where each Aᵢⱼ represents an edge (Cᵢ, Sⱼ) with fᵢⱼ!=0; and k is the number of edges that meet this criteria. Each Aᵢⱼ has the fomm:

L Sⱼ.SSET_CNAME,

where L=(fᵢⱼ|uᵢⱼ)−P. Recall that P is the minimum percentage to be served from the origin site. Also, recall that each CLUSTER_DESCRIPTION contains one or more IP network address prefix. If a CLUSTER_DESCRIPTION contains multiple IP network prefixes, an entry for each IP network prefix is created using the same values for fᵢⱼ, uᵢⱼ and Sⱼ. Also, if there does not exist an edge (Cᵢ, S₀) with fᵢⱼ>0 for any cluster, then Aᵢ₀ is created of the form:

P S₀.SSET_CNAME

where S₀.SSET_CNAME is the name referring to the origin site. Likewise, if only edge (Cᵢ, S₀) has fᵢⱼ>0, then Aᵢ₀ is created of the form:

1 S₀.SSET_CNAME

The map generated by map builder 112 may be recalculated at regular intervals, which can be specified by the content publisher.

In step 210, map builder 112 then sends the map to redirector 116. The redirector, when subsequently presented with an client IP address, will then search for the cluster that includes the client's IP address in the map, retrieve the list of SSET_CNAME's (and associated load percentages) associated with that cluster, and select from amongst Cᵢ's assigned SSET_CNAME's. The following algorithm enables the redirector to randomly select from this list, while maintaining the distribution of requests to SSET_CNAMES specified by their associated L values.

k = number of SSET_CNAMES associated with this cluster
r = random number assigned to this particular client request;
where 0 <= r <= 100
region=0
for (j=0; j<k; j++) {

region += Aᵢⱼ.L;
if (r < region) {

return j;

}

}

The following portion of the detailed description will now illustratively explain how the information used as input for the map creation methodology is generated.

The SSET_CNAME is provided by the service provider. The service provider also provides a value for SSET_MAX_CAPACITY; the content publisher may decide to reduce this maximum capacity to limit the amount of traffic directed to the remote server set. The service provider will also provide a list of SSET_SERVICE_POINTS, and SSET_COST. The content publisher may also wish to not consider certain SSET_SERVICE_POINTS, if it does not want to use specific service points.

The CLUSTER_DESCRIPTION's, i.e., the list of IP addresses that belong to a given cluster, can be determined in a number of ways. The objective of clustering is to group together client addresses with similar location. i.e., client addresses that have a similar distance measure to remote nodes (servers) within the network. The invention is not dependent on the method used to cluster addresses, which is an important feature since different content publishers may wish to use different methods depending on the delivery requirements. One clustering method that may be used in an embodiment of the invention will now be illustratively explained.

The exemplary clustering utilizes input including round trip time (RTT) measurements to client IP addresses collected from probing servers deployed at geographically and topologically distributed locations. An example of a tool commonly used to collect RTT data is the traceroute tool. Client IP addresses may be grouped, for example, according to the 24-bit network address prefix. That is, IP addresses that differ only by the last octet in their IP address are probed and tracked as a unit. We refer to addresses grouped in this manner as IP address prefixes. We refer to the collective RTT information from all probing servers to a single IP address prefix as the coordinates of the IP address prefix. A weight, representing the expected load imposed by requests from clients with this IP address prefix, is assigned to each IP address prefix based on historical client request data.

Using the described IP prefix coordinates and weights, IP addresses can be clustered as follows:

1. Select a network distance threshold and group proximal IP address prefixes, i.e., IP address prefixes with coordinates within this network distance threshold. To each group, assign:

a weight, which is the sum of the weights of the proximal IP address prefixes.

coordinates, which is the centroid of the proximal IP address prefixes.

2. Select a number key network locations, where the significance of a network location is based on weight assigned the group at that network location. We refer to these key network locations as virtual stations.

3. Assign each IP address prefix to the nearest virtual station, based on the coordinates of the virtual stations and the coordinates of the IP address prefix.

4. Update the coordinates of each virtual station by computing the weighted centroid of all IP address prefixes assigned the virtual station.

5. Repeat steps 3-4 until the computed centroids are unchanged across two iterations, or a maximum number of iterations is exhausted.

6. The coordinates of each virtual station is the CLUSTER_LOCATION for the corresponding cluster, and the IP addresses assigned to this station represent the CLUSTER_DESCRIPTION for the corresponding cluster.

A description will now be given of how the distance (Cᵢ, Cₖ) between a pair of clusters and the distance (Cᵢ, Sⱼ) between a cluster and a server set is calculated.

The distance between a pair of clusters, Cᵢ, Cₖ, is calculated as follows. First, the minimum estimated latency for Cᵢ and Cₖ is found. The probe site that reported this minimum estimated latency is referred to as Cᵢ.closestProber and Cₖ.closestProber. The distance is the sum of the measured latency from Cᵢ.closestProber to Cᵢ, from Cₖ.closestProber to Cₖ, and the average of probes between Cᵢ.closestProber and Cₖ.closestProber.

It is to be noted that, just as the invention is not limited to this particular clustering mechanism, it is not limited to this particular distance estimation technique. For example, systems exist to estimate the location of an IP address in terms of geographic longitude and latitude. The invention has the advantage that alternative distance estimation and clustering mechanisms can be used, and the changes are isolated from the techniques for optimizing assignment.

In order to describe how the distance between a cluster, Cᵢ, and a server set, Sⱼ, is calculated, some background information will be provided.

First, what is meant by “distance between a cluster and a server set” is described, since a server set will be both geographically and topologically distributed. Therefore, since the distance to be calculated is not between two distinct points, a method is provided for evaluating the expected distance between clients within a specified cluster, and a specified set of servers. Note that:

$$DISTANCE ( {C}_{i} , {S}_{j} ) = {\sum }_{k = 1}^{t} {α}_{ik} * DISTANCE ( {C}_{i} , findCluster ( {s}_{jk} ) )$$

where findCluster (sⱼₖ) returns the cluster of the provided IP address, sⱼₖ, and sⱼₖ is the k^{th} surrogate of server set Sⱼ. The value αᵢₖ is the probability that a client from cluster Cᵢ, when directed to server set Sⱼ, will be routed to surrogate sⱼₖ. This probability is not constant in time, but is determined according to policies, or rules, established by the entity deploying the server set.

Examples of configurable rules often include: health of servers (e.g., is server up?); available capacity of servers; RTT between server and client network; geographic location of server and client; least number of requests or connections; round robin; administrative priority; client IP address; and time of day.

Note that these rules are used by the mechanism within the service provider network, and are generally considered to be proprietary information, which is not generally accessible outside of the server set provider. Further, values (e.g., available capacity of servers) vary with time.

Finally, the server to which a client ultimately sends its request is not fully determined by the load balancing mechanism. An agent of the client, and not necessarily the client itself, may retrieve the server selection response from the load balancing mechanism. These agents may cache this information, and/or provide it to multiple clients. Clients may also cache the response from the agent or load balancing mechanisms.

The server set selection methodology therefore provides a method to estimate the expected distance, and may do so without disclosure of the service provider policies deemed proprietary, and with limited status information from the service provider.

Three illustrative mechanisms for evaluating distance, based on varying levels of information provided by the service provider, will be described. The mechanism for evaluating distance is invoked by map builder 112. The interface between map builder 112 and the component evaluating cluster to server set distances is referred to as the distance monitor, shown in FIG. 1A as distance monitor 118.

The flow for instantiating and invoking the distance monitor is as follows. Map builder 112 establishes a communications channel with the service provider for the ServicePointStatusChannel. Map builder instantiates the distance monitor 118 provided by the service provider and passes the handle for the ServicePointStatusChannel to the distance monitor object. When distance information for the server set is required, map builder invokes the distance (Cᵢ) method of the server set's distance monitor. The interface is:

class distanceMonitor {

| | |
|---|---|
| distanceMonitor( ); | // constructor |
| ˜distanceMonitor( ); | // destructor |

// initialize is called once, before any
// calls to the distance method
bool initialize(ServicePointStatusChannel, ServerSetID);
// distance is invoked to evaluate the distance from
// the server set specified by ServerSetId and the
// input Cluster.
int distance(Cluster);

}

where ServicePointStatusChannel is a handle to a communications channel over which service provider status information is communicated, and Cluster is an IP address mask. Status information is communicated over the ServicePointStatusChannel in the form:

SP_IP_ADDRESS SP_RATING SP_WGT

where the SP_IP_ADDRESS identifies the IP address, or IP address block if the Service Point includes multiple caches or multiple network interfaces. The SP_RATING is an integer value in the range 0-10. This value is intended to reflect the available capacity of the surrogate, with zero indicating the server is servicing a load equivalent to its capacity (i.e., the server is fully loaded). The larger the value, the greater the available capacity of the server. The service provider will update the list of surrogates at regular intervals, and when a change in rating of greater than Δ occurs. Δ is a percentage that is agreed upon by the content publisher and the service provider. The SP_WGT is an administrative weight assigned to the surrogate.

This information may be used to determine an estimated distance in accordance with one of the three following illustrative approaches. However, as mentioned above, the invention is not limited to any particular distance evaluation approach.

(a) Policy-Driven Distance Evaluation

In this first method, the service provider will periodically communicate to which surrogates it is directing requests from clients of the content publisher, and the rating and weight of that server over the ServicePointStatusChannel.

The policy, or rules, driven load balancing implemented by the service provider are abstracted to derive the value of αᵢₖ in the distance calculation as follows. The surrogates within a server set that are available with a rating >R are determined. The default value of R is 2, but can be agreed upon between the content publisher and service provider. For those servers which meet the availability and rating criteria, the minimum expected distance, i.e., distance (Cᵢ, findCluster (sⱼₖ)), is determined. The set of surrogates with distance (Cᵢ,findCluster (sⱼₖ)) within β of the minimum expected distance of available servers is then determined. The value of β is 10%, but can be agreed upon between the content publisher and service provider. For those servers which meet these availability, rating, and latency criteria, αᵢₖ is set to SP_WGT/τ where τ is the sum of the weights of all surrogates meeting the criteria.

The service provider is not required to communicate the weight and rating of its service points over the ServicePointStatusChannel. For example, a service provider may distribute requests to service points according to a policy that does not vary with time or load. In such cases, this policy is communicated to the content provider when service is agreed upon.

(b) Provider-Mediated Distance Evaluation

It is anticipated that some service providers' policies may be too complex to accurately model with the abstracted policy-based evaluation just described, or that the service provider may not wish to divulge surrogate rating or weight information to content publishers. Thus, the invention enables content publishers to estimate distance (Cᵢ, Sⱼ), while meeting these constraints.

Specifically, a solution provides the ability to have service providers provide the distance monitor for their server set. The map builder then instantiates the service provider's distance monitor, instead of the default policy-based distance monitor described above.

The following differences are noted between the distance monitor described for the policy-driven scenario and that for the service provider-mediated scenarios. The service provider's distance monitor may, or may not, invoke the map builder's distance (Cᵢ, Cⱼ) method in its distance evaluation. In instances where the map builder's distance (Cᵢ, Cⱼ) method is not used, distance information may be communicated over the ServicePointStatusChannel. The information communicated in the ServicePointStatus Channel communicates surrogate information, but may not be in the address, rating, weight form described above. It also may be communicated in some secured (encrypted) form. The algorithm implemented in the distance (Cᵢ) method may follow that described for the policy-driven method, or it may implement some proprietary mechanism.

Provider-mediated distance evaluation enables service providers to communicate status information, and evaluate distance, in a proprietary manner. A content publisher may choose to override this evaluation, or may discontinue partnering with a service provider that does not provide usable distance evaluation information.

(c) Measurement-Based Distance Evaluation

Measurement-based distance evaluation provides a second alternative to the policy-based method. In this case, probing is performed to determine, statistically, to which servers within a given set client requests are directed. This probing may be done by the content publisher, by positioning distributed probe sites, or by the service provider, by passively collecting data at surrogates within the server set. This information may be of the form:

SERVER_ID CLUSTER_ID NUMBER_REQUESTS TIME_UNITS

where SERVER_ID (sⱼₖ) identifies the IP address of a surrogate and CLUSTER_ID (Cᵢ) identifies the IP address prefix of the cluster. NUMBER_OF_REQUESTS indicates the number of client requests received by the associated SERVER_ID for the associated CLUSTER_ID in the time specified by TIME_UNITS. That is, NUMBER_OF_REQUESTS/TIME_UNITS=αᵢₖ.

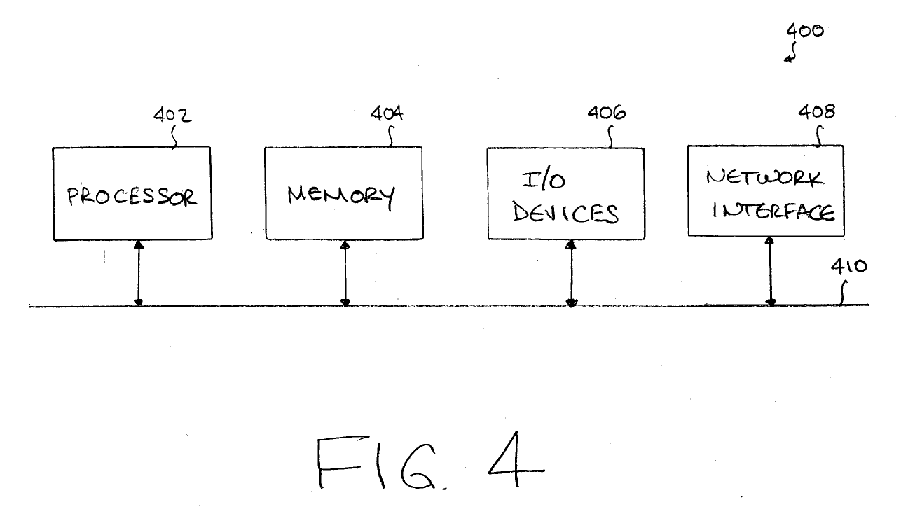

Referring now to FIG. 4, a block diagram illustrates an exemplary computing system environment for implementing a server selection system according to an embodiment of the present invention. More particularly, the functional blocks illustrated in FIG. 1A (e.g., map builder, distance monitor, redirector) and FIG. 1B (e.g., map building controller, server set interface, cluster analysis module, traffic monitor) may implement such a computing system 400 to perform the techniques of the invention. For example, one or more servers implementing the server selection principles of the invention may implement such a computing system. A client device may also implement such a computing system. Of course, it is to be understood that the invention is not limited to any particular computing system implementation.

In this illustrative implementation, a processor 402 for implementing at least a portion of the methodologies of the invention is operatively coupled to a memory 404, input/output (I/O) device(s) 406 and a network interface 408 via a bus 410, or an alternative connection arrangement. It is to be appreciated that the term “processor” as used herein is intended to include any processing device, such as, for example, one that includes a central processing unit (CPU) and/or other processing circuitry (e.g., digital signal processor (DSP), microprocessor, etc.). Additionally, it is to be understood that the term “processor” may refer to more than one processing device, and that various elements associated with a processing device may be shared by other processing devices.

The term “memory” as used herein is intended to include memory and other computer-readable media associated with a processor or CPU, such as, for example, random access memory (RAM), read only memory (ROM), fixed storage media (e.g., hard drive), removable storage media (e.g., diskette), flash memory, etc.

In addition, the phrase “I/O devices” as used herein is intended to include one or more input devices (e.g., keyboard, mouse, etc.) for inputting data to the processing unit, as well as one or more output devices (e.g., CRT display, etc.) for providing results associated with the processing unit.

Still further, the phrase “network interface” as used herein is intended to include, for example, one or more devices capable of allowing the computing system 400 to communicate with other computing systems. Thus, the network interface may include a transceiver configured to communicate with a transceiver of another computing system via a suitable communications protocol, over a suitable network, e.g., the Internet, private network, etc. It is to be understood that the invention is not limited to any particular communications protocol or network.

It is to be appreciated that while the present invention has been described herein in the context of a server selection system, the methodologies of the present invention may be capable of being distributed in the form of computer readable media, and that the present invention may be implemented, and its advantages realized, regardless of the particular type of signal-bearing media actually used for distribution. The term “computer readable media” as used herein is intended to include recordable-type media, such as, for example, a floppy disk, a hard disk drive, RAM, compact disk (CD) ROM, etc., and transmission-type media, such as digital and analog communication links, wired or wireless communication links using transmission forms, such as, for example, radio frequency and optical transmissions, etc. The computer readable media may take the form of coded formats that are decoded for use in a particular data processing system.

Accordingly, one or more computer programs, or software components thereof, including instructions or code for performing the methodologies of the invention, as described herein, may be stored in one or more of the associated storage media (e.g., ROM, fixed or removable storage) and, when ready to be utilized, loaded in whole or in part (e.g., into RAM) and executed by the processor 402.

In any case, it is to be appreciated that the techniques of the invention, described herein and shown in the appended figures, may be implemented in various forms of hardware, software, or combinations thereof, e.g., one or more operatively programmed general purpose digital computers with associated memory, application-specific integrated circuit(s), functional circuitry, etc. Given the techniques of the invention provided herein, one of ordinary skill in the art will be able to contemplate other implementations of the techniques of the invention.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method of generating a reference list for use in selecting at least one computing system associated with a first plurality of computing systems to which another computing system associated with a second plurality of computing systems is to be directed, the method comprising the steps of:
obtaining input data, the input data comprising information associated with the first plurality of computing systems, information associated with the second plurality of computing systems, and information associated with content requests made by at least a portion of the second plurality of computing systems;
computing a minimum cost assignment based on at least a portion of the obtained input data; and
computing a reference list based on the minimum cost assignment, the reference list being useable for selecting, upon request, at least one computing system associated with the first plurality of computing systems to which a computing system associated with the second plurality of computing systems is to be directed.

2. The method of claim 1, wherein the minimum cost assignment is computed such that a distance threshold is not exceeded.

3. The method of claim 1, wherein the minimum cost assignment is computed such that resource availability of the first plurality of computing systems is not violated.

4. The method of claim 1, wherein the first plurality of computing systems comprises servers in a distributed computing network and the second plurality of computing systems comprises client devices in the distributed computing network.

5. The method of claim 4, wherein the input information associated with the first plurality of computing systems comprises server set attribute data.

6. The method of claim 4, wherein the input information associated with the second plurality of computing systems comprises client device clustering information.

7. The method of claim 1, wherein the assignment computation step comprises construction and use of a flow graph.

8. The method of claim 7, wherein the assignment computation step comprises use of optimization operations in accordance with the flow graph.

9. The method of claim 1, wherein the reference list comprises an optimized mapping between computing systems associated with the first plurality of computing systems and computing systems associated with the second plurality of computing systems.

10. The method of claim 1, further comprising the step of clustering computing systems associated with the second plurality of computing systems based on round trip time measurements.

11. The method of claim 1, wherein the assignment computation step is at least partially based on distances between computing systems associated with the first plurality of computing systems and the second plurality of computing systems.

12. The method of claim 11, wherein measurement of distances is based on at least one of a policy-driven distance evaluation criterion, a provider-mediated distance evaluation criterion, and a measurement-based distance evaluation criterion.

13. Apparatus for generating a reference list for use in selecting at least one computing system associated with a first plurality of computing systems to which another computing system associated with a second plurality of computing systems is to be directed, the apparatus comprising:
a memory; and
at least one processor coupled to the memory and operative to: (i) obtain input data, the input data comprising information associated with the first plurality of computing systems, information associated with the second plurality of computing systems, and information associated with content requests made by at least a portion of the second plurality of computing systems; (ii) compute a minimum cost assignment based on at least a portion of the obtained input data; and (iii) compute a reference list based on the minimum cost assignment, the reference list being useable for selecting, upon request, at least one computing system associated with the first plurality of computing systems to which a computing system associated with the second plurality of computing systems is to be directed.

14. The apparatus of claim 13, wherein the minimum cost assignment is computed such that a distance threshold is not exceeded.

15. The apparatus of claim 13, wherein the minimum cost assignment is computed such that resource availability of the first plurality of computing systems is not violated.

16. The apparatus of claim 13, wherein the first plurality of computing systems comprises servers in a distributed computing network and the second plurality of computing systems comprises client devices in the distributed computing network.

17. The apparatus of claim 16, wherein the input information associated with the first plurality of computing systems comprises server set attribute data.

18. The apparatus of claim 16, wherein the input information associated with the second plurality of computing systems comprises client device clustering information.

19. The apparatus of claim 13, wherein the assignment computation operation comprises construction and use of a flow graph.

20. The apparatus of claim 19, wherein the assignment computation operation comprises use of optimization operations in accordance with the flow graph.

21. The apparatus of claim 13, wherein the reference list comprises an optimized mapping between computing systems associated with the first plurality of computing systems and computing systems associated with the second plurality of computing systems.

22. The apparatus of claim 13, wherein the at least one processor is further operative to cluster computing systems associated with the second plurality of computing systems based on round trip time measurements.

23. The apparatus of claim 13, wherein the assignment computation operation is at least partially based on distances between computing systems associated with the first plurality of computing systems and the second plurality of computing systems.

24. The apparatus of claim 23, wherein measurement of distances is based on at least one of a policy-driven distance evaluation criterion, a provider-mediated distance evaluation criterion, and a measurement-based distance evaluation criterion.

25. An article of manufacture for generating a reference list for use in selecting at least one computing system associated with a first plurality of computing systems to which another computing system associated with a second plurality of computing systems is to be directed, comprising a machine readable medium containing one or more programs which when executed implement the steps of:
obtaining input data, the input data comprising information associated with the first plurality of computing systems, information associated with the second plurality of computing systems, and information associated with content requests made by at least a portion of the second plurality of computing systems;
computing a minimum cost assignment based on at least a portion of the obtained input data; and
computing a reference list based on the minimum cost assignment, the reference list being useable for selecting, upon request, at least one computing system associated with the first plurality of computing systems to which a computing system associated with the second plurality of computing systems is to be directed.

26. The article of claim 25, wherein the minimum cost assignment is computed such that a distance threshold is not exceeded.

27. The article of claim 25, wherein the minimum cost assignment is computed such that resource availability of the first plurality of computing systems is not violated.
